(19) United States
(12) Patent Application Publication
(10) Pub. No.: US 2017/0063616 A1
(43) Pub. Date: Mar. 2, 2017

(54) RAPID RESPONSE NETWORKING KIT

(71) Applicant: TacSat Networks LLC, San Juan Bautista, CA (US)

(72) Inventor: Brad KLEMEK, San Juan Bautista, CA (US)

(21) Appl. No.: 15/248,374

(22) Filed: Aug. 26, 2016

Related U.S. Application Data
(60) Provisional application No. 62/210,892, filed on Aug. 27, 2015.

(51) Int. Cl. H04L 12/24; H04L 12/26

(52) U.S. Cl. CPC H04L 41/0809; H04L 41/0886; H04L 41/22; H04L 43/10; H04L 41/0663; H04W 88/08

(57) ABSTRACT

A rapid response network (RRN) is provided. The RRN includes a router having a connection to a data service. The RRN also includes a hub having a mac address, the hub communicatively coupled with the router. In addition, the RRN includes at least one node having a mac address, the at least one node communicatively coupled with the hub, the at least one node manually configured to only communicate with the hub as designated by the hub mac address.

### CROSS-REFERENCE TO RELATED APPLICATIONS (PROVISIONAL)

This application claims priority to and benefit of co-pending U.S. Provisional Patent Application No. 62/210,892 filed on Aug. 27, 2015, entitled “RAPID RESPONSE NETWORKING KIT” by Brad Klemek, and assigned to the assignee of the present application, the disclosure of which is hereby incorporated herein by reference in its entirety.

### TECHNICAL FIELD

Examples described herein relate to a rapid response networking kit.

### BACKGROUND

In the present connected world, having a reliable network can be very important. However, even the most reliable network can be overwhelmed with traffic, slowed by hackers, and even go dark due to power outages or physical damage.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description should not be understood as being drawn to scale unless specifically noted.

FIG. 1 is a network diagram of a rapid response network, in accordance with an embodiment.

FIG. 2 is a flowchart of a method for forming a rapid response network, in accordance with an embodiment.

FIGS. 3A-3D are a plurality of screen shots illustrating the programing the router of rapid response network, in accordance with an embodiment.

FIGS. 4A-4C are a plurality of screen shots illustrating the programing procedure for each node, in accordance with an embodiment.

FIGS. 5A-5C are a plurality of screen shots illustrating the programing procedure for each of the shorter range nodes, in accordance with an embodiment.

FIGS. 6A-6C are a plurality of screen shots illustrating the programing procedure for a longer range master node, in accordance with an embodiment.

FIGS. 7A-7C are a plurality of screen shots illustrating the programing procedure for each of the longer range slave nodes, in accordance with an embodiment.

FIG. 8 is a block diagram of an example computer system with which or upon which various embodiments of the present invention may be implemented.

### DETAILED DESCRIPTION

Reference will now be made in detail to embodiments of the subject matter, examples of which are illustrated in the accompanying drawings. While the subject matter discussed herein will be described in conjunction with various embodiments, it will be understood that they are not intended to limit the subject matter to these embodiments. On the contrary, the presented embodiments are intended to cover alternatives, modifications and equivalents, which may be included within the spirit and scope of the various embodiments as defined by the appended claims. Furthermore, in the Description, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### Overview

The rapid response network discussed herein will provide or replace critical network infrastructure that may not exist or may not be functional due to a disaster, emergency circumstances or remote operational locations. For example, in a disaster response, the rapid response network may be deployed within a very short time period to provide network connectivity for first responders, aid workers, government agencies, local agencies and the like.

Moreover, the rapid response network can also be deployed as a secondary network, e.g., a command and control network, parallel network, or the like. For example, in an event such as a football game, there may be an operational network, e.g., the “game” network. The “game” network may include cellular, WiFi, and the like. The “game” network may be open to any person, to paying customers, or the like. However, for reliability, security, back-up purposes, or the like, the rapid response network may also be desired. For example, the rapid response network may be running in parallel to the “game” network. In this case, the rapid response network will operate outside of the “game” network. Moreover, the rapid response network may be a limited access network, e.g., only authorized devices will be able to utilize the “security” network. Thus, regardless of how the “game” network is operating, the rapid response network would be available.

Thus, the rapid response network will assist any agency, business or planned event with the needed connectivity to insure continuity in communications. Moreover, in one embodiment, the rapid response network may be packed into a single case such as, but not limited to, a Pelican™ 1690 case with lid organizer. The case is rugged and protects rapid response network in almost any conditions. It is water and air tight and will float with all the components inside. When packed, and depending upon the configuration, the rapid response network may weigh approximately 83 lbs. and would be airline checkable.

### Operation

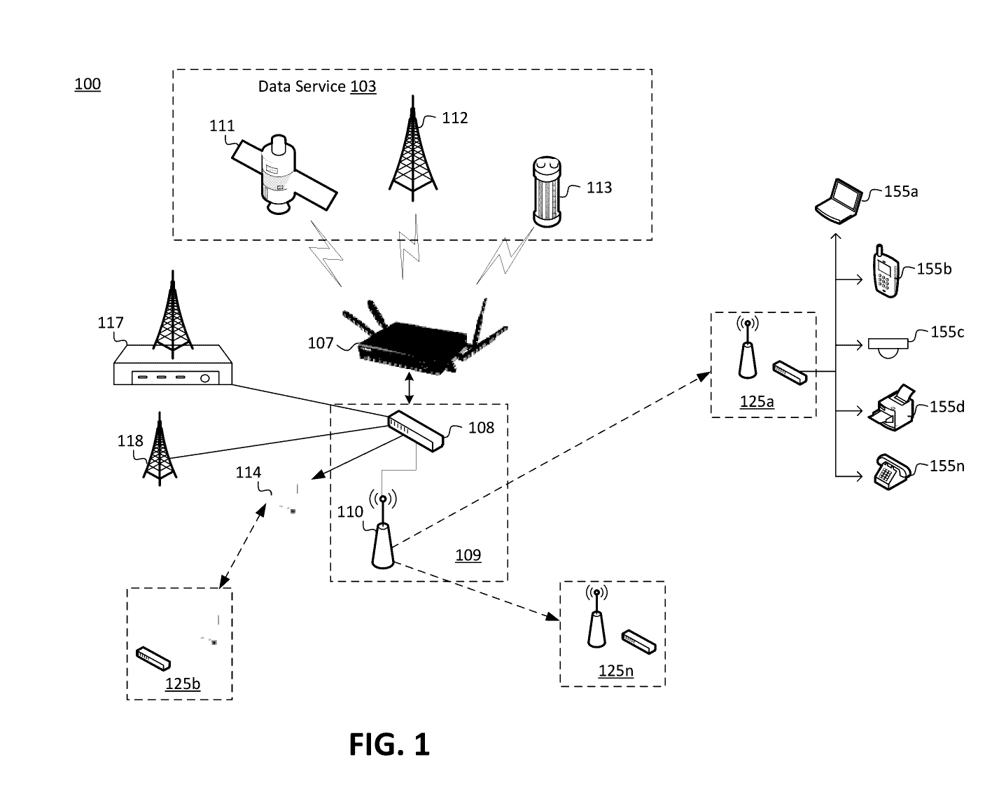

With reference to FIG. 1, a rapid response network 100 is shown in accordance with an embodiment. Rapid response network 100 includes a data service 103, a router 107, a hub 109, and at least one node 125a-125n. Rapid response network 100 may also include one or more of an optional cellular network extender 117, a land based radio system 118, or a digital radio gateway 118.

Data service 103 can include network connections such as a satellite network connection 111, e.g., Ka band, a long-term evolution (LTE) network connection 112, a wired network connection 113, or the like. In one embodiment, the wired network connection 113 can be one or more of a cable network connection, a digital subscriber line (DSL) network connection, an optical fiber network connection and the like.

In general, LTE is a standard for high-speed wireless communication for mobile phones and data terminals. DSL is a technology for bringing high-bandwidth information to homes and small businesses over ordinary copper telephone lines.

In one embodiment, satellite network connection 111 is established via a device, such as, but not limited to, a ViaSat Inc. Surfbeam 2 Pro Portable Ka Band VSAT. In general, satellite network connection 111 will provide an unrestricted and reliable 15 Mbps of download speed and 5 Mbps upload speed. This unit commonly will operate at speeds of 20 Mbps down and 10 Mbps up. Satellite network connection 111 will operate on both AC and 12 volts DC power.

In the present discussion, router 107 has a connection to data service 103. In one embodiment, router 107 is connected to a single data service 103. However, in another embodiment, router 107 may have connections to two or more data service 103 providers.

The hub 109 of rapid response network 100 is communicatively coupled with router 107. In one embodiment, hub 109 can include a switch 108 and a wireless access point 110. In one embodiment, hub 109 is manually configured to only communicate with at least one node 125a-125n as designated by the mac address of the at least one node. An example of switch 108 includes, but is not limited to, a netgear 8 port switch.

At least one node 125a-125n has a MAC address and is communicatively coupled with hub 109. In one embodiment, the at least one node 125a-125n is manually configured to only communicate with the hub as designated by the hub mac address. In other words, the MAC address of hub 109 is manually provided to at least one node 125a-125n such that when the at least one node 125a-125n is powered on, or operational, the node(s) do not search for other broadcasting stations, but instead communicate only with the hub 109 having the designated MAC address. In so doing, the network will be more stable and less prone to interference and the like.

In general, the at least one node could be one or more shorter range nodes such as node 125a that utilizes a 2.4 GHz link for shorter distances such as up to approximately ½ mile; one or more longer range nodes such as node 125b that works with high gain antenna 114 and utilizes a 5 GHz link for longer distances, e.g., it can be placed distances up to 3 miles line of sight from hub 109; or a combination of shorter and longer range nodes.

In one embodiment, rapid response network 100 will include a plurality of nodes, each of the plurality of nodes having a different mac address, the plurality of nodes communicatively coupled with hub 109, the plurality of nodes manually configured to only communicate with hub 109 as designated by a previously provided hub mac address. Although the nodes may be of different manufacture and operational characteristics, one example of node 125a is a Ubiquiti Bullet M2-TI wireless network node that operate on the unlicensed 2.4 Ghz. wireless band. Similarly, one example of node 125b is a Ubiquiti Bullet M5-TI wireless network node that operate on the 5 Ghz. unlicensed band.

However, one problem with node deployment occurs when more than 2 units are deployed at the same time within wireless range of each other. For example, off the shelf the Ubiquiti M2 and M5 Bullets are factory programed so once the user powers them on, they will start seeking out any other Ubiquiti Bullets and attempt to link. This approach by Ubiquiti allows for a purely plug and play operation. However, when attempting to utilize the nodes 125a-125n in configurations that rapid response network 100 is capable of, the nodes 125a-125n will in most all cases fail to link, or network performance (network bandwidth capacity) dramatically drops by over 75% and becomes very unstable.

In one embodiment, by steering each node 125a-125n by MAC addresses and locking all nodes to a single unified frequency along with some further refinements such as, unified SSID's and network passwords, a user can freely move throughout the covered areas seamlessly while maintaining network connectivity.

Moreover, at least one node 125a-125n may additionally receive MAC addresses for other nodes of at least one node 125a-125n, to which the node is authorized to link. That is, the at least one node 125a-125n can be manually configured to only allow designated linking, and not dynamic linking, with another node, the designated linking based on a predefined node mac address.

In addition, in one embodiment, the at least one node 125a-125n is manually configured to only communicate with hub 109 on a predefined frequency.

In one embodiment, one or more devices 155a-155n are communicatively coupled with the at least one node 125a-125n. For example as shown at node 125a, the one or more devices can include, but are not limited to a computer system 155a, a mobile communications device 155b, a camera 155c, a printer 155d, a voice over IP telephone 155n, and the like.

In a secure rapid response network 100 each of at least one node 125a-125n may also be provided with an access control list. The access control list would include a list of authorized devices. The authorized devices would be devices that have been authorized to utilize one or more of the at least one node 125a-125n on rapid response network 100. For example, if rapid response network 100 was a private network, in order for a device to access rapid response network 100 it would have to be on the list of authorized devices for the network. As such, if an unauthorized device attempted to access rapid response network 100 it would not be as simple as guessing the network password as the network would still check the authorized device list before providing access.

In one embodiment, each of the router 107, the hub 109, and the at least one node 125a-125n operate on 12 volt DC power. The power may be received from a battery, a solar power source, or the like. For example, the solar power source is established via a device, such as, but not limited to, a GOAL ZERO™ to provide a robust solar power system. In one embodiment, the system consists of (3) Yeti 150 solar power units with Noman 20 collapsible solar panels. These units are well suited to operate the at least one node 125a-125n along with VoIP modems, network switches, and laptops over extended periods of time when utilizing the solar panels. In addition a Yeti 400 solar power unit with an additional (2) Nomad 20 solar panels are used to power the router 107, and other rapid response network 100 components. The Yeti 400 provides the additional power required to run the satellite network connection 111 radio.

In one embodiment, optional cellular network extender 117 creates a cell tower to provide cellular phone service capabilities to the rapid response network. An example of a cellular network extender is, but not limited to, a Verizon Micro Cell™. In general, cellular network extender 117 gives the ability of creating a micro cell tower where one doesn't exist, failure of an existing provider's tower, or due to conditions that overloads the provider's towers rendering cellular phone service impossible. In one embodiment, rapid response network 100 can register up to 50 cellular phones at a time with the provider's network for incoming and outgoing phone calls. In addition, a “white list” can be created and upload to restrict access. The device utilizes one or more of the data service 103 connections to port the user's phone calls directly to the provider's network effectively bypassing the need for a cell tower, this is all done automatically with no user intervention.

Thus, rapid response network 100 cellular network extender or Micro Cell adds the ability to create a cellular micro tower that acts just like any full service cellular tower. The unit requires a stable internet connect to operate. As such, with the stable VSAT connectivity of rapid response network 100 it is possible to use Micro Cells over a space based connection. In one embodiment, the cellular network extender 117 provides standard cellular service for all the major network provides that does not utilize or require the provider's towers. This unit creates its own tower that can be used over the VSAT link. The range allows cellular network extender 117 to be used as a normal cellular tower or in areas void of any service, remote locations to assist emergency personnel for communications or ping for missing persons in the back country and in an urban setting searchers can use the system to find trap people in large scale building collapses.

The optional land based radio system and/or digital radio gateway 118 provide RF radio connectivity to the rapid response network 100. Moreover, one or more of the at least one node 125a-125n may act as a Wi-Fi hotspot.

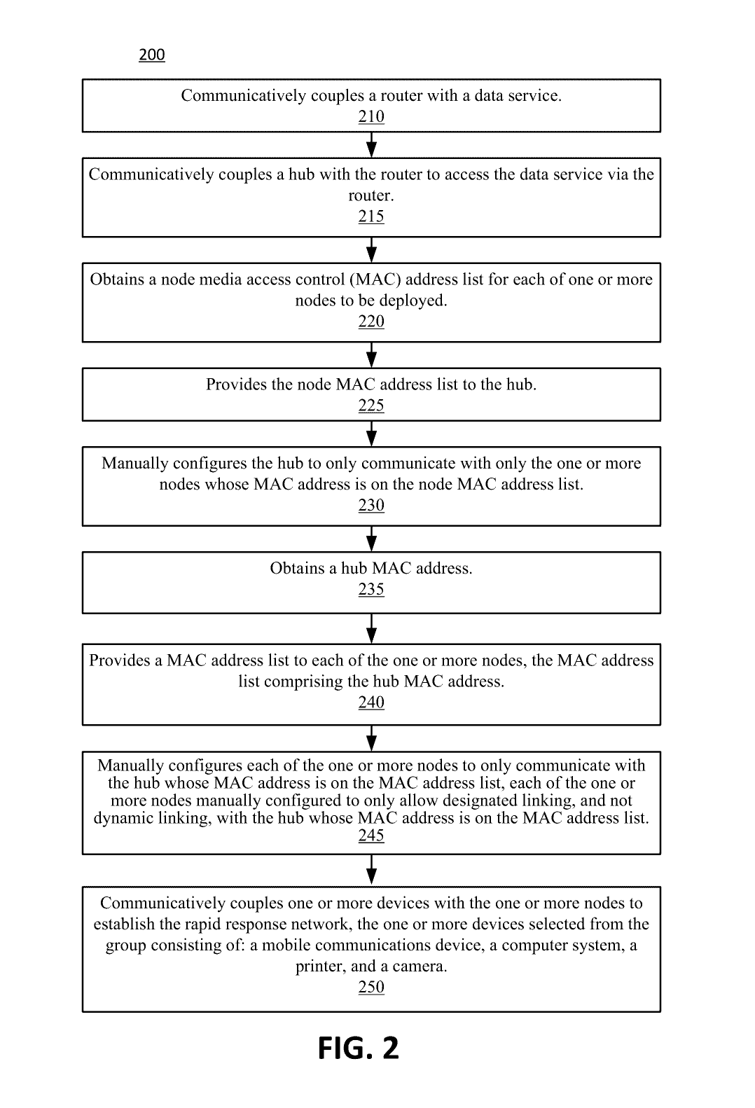

Referring now to FIG. 2, a flowchart of a method for forming a rapid response network 100 is shown in accordance with an embodiment. In one embodiment, rapid response network 100 is a one box plug & play solution that will support a small single agency response or scales up to handle a large regional type-1 incident. The system has the ability to rapidly replace or establish critical infrastructure including wireless or wired network services, phone service via a VoIP modem that provide simple dial tones, cellular phone service connectivity, high speed LTE, or space based VSAT internet connectivity anytime, and anywhere under most any conditions.

Rapid response network 100 is easy to deploy, reliable and scalable. Rapid response network 100 has unique component programming that allows unskilled personnel to deploy the system quickly. It is just a matter of locating the areas to be covered and to plug in power cables. The systems program will take over automatically taking care of the technical routing and critical functional setup on its own.

Rapid response network 100 utilizes two different strategies in wireless technology “Point to Multipoint” and “Point to Point” operating in both the 2.4 Ghz. and 5 Ghz. frequency band. The system can be powered on ether AC and/or 12 volt DC power. It has very low power requirements which makes rapid response network 100 well suited for battery or solar operation. This allows versatility in connecting work groups in a single location (Base Camp, building) or bridging multiple work groups in different locations or buildings that can be up to miles apart.

For example, a small rapid response network 100 setup may deploy a single node, e.g., node 125a, creating a wireless access point to the internet, phones, or cellular service. This can be functional for a small operation and then scale the system up as needed with a plurality of additional nodes, e.g., nodes 125b through 125n, that have the ability to cover large base camps, ICP's, corporate facilities or events. As the rapid response network 100 is scalable on the fly, the Rapid response network 100 can be grown from a small single node network to a plurality of nodes network by deploying the additional nodes, placing them in the desired locations and powering them up. At that point, the rapid response network 100 programing will take over and make the appropriate connections.

With reference now to 210 of FIG. 2, one embodiment communicatively couples a router 107 with a data service 103. Although a number of routers may be utilized to act as router 107, for purposes of enablement, the discussion will specifically refer to Cradlepoint™ AER-2100 Enterprise Class router/modem as one exemplary embodiment.

In one embodiment, router 107 has the ability to provide rapid response network 100 with unsurpassed LTE speed with its built in duel LTE high power modems that work together in tandem balancing the network loads. This allows rapid response network 100 to handle a single user or a 100 plus users all automatically without any additional intervention. After adding a Ka Band VSAT systems to rapid response network 100, router 107 will prioritize, balance and monitor connectivity of all the connected WAN (Wide Area Network) resources insuring reliable, cost effective broadband connectivity at all times. This is all accomplished automatically or by logging into a GUI and change priorities, traffic flow, and the like.

With reference now to 215 of FIG. 2, one embodiment communicatively couples hub 109 with router 107 to access the data service 103 via router 107.

Referring now to 220 of FIG. 2, one embodiment obtains a node media access control (MAC) address list for each of one or more nodes 125a-125n to be deployed.

With reference now to 225 of FIG. 2, one embodiment provides the node MAC address list to hub 109.

Referring now to 230 of FIG. 2, one embodiment manually configures hub 109 to only communicate with only the one or more nodes 125a-125n whose MAC address is on the node MAC address list.

With reference now to 235 of FIG. 2, one embodiment obtains a hub 109 MAC address.

Referring now to 240 of FIG. 2, one embodiment provides a MAC address list to each of the one or more nodes 125a-125n, the MAC address list comprising the hub 109 MAC address.

With reference now to 245 of FIG. 2, one embodiment manually configures each of the one or more nodes 125a-125n to only communicate with hub 109 whose MAC address is on the MAC address list. That is, each of the one or more nodes 125a-125n is manually configured to only allow designated linking, and not dynamic linking, with hub 109 whose MAC address is on the MAC address list.

Referring now to 250 of FIG. 2, one embodiment communicatively couples one or more devices 155a-155n with the one or more nodes 125a-125n to establish the rapid response network 100.

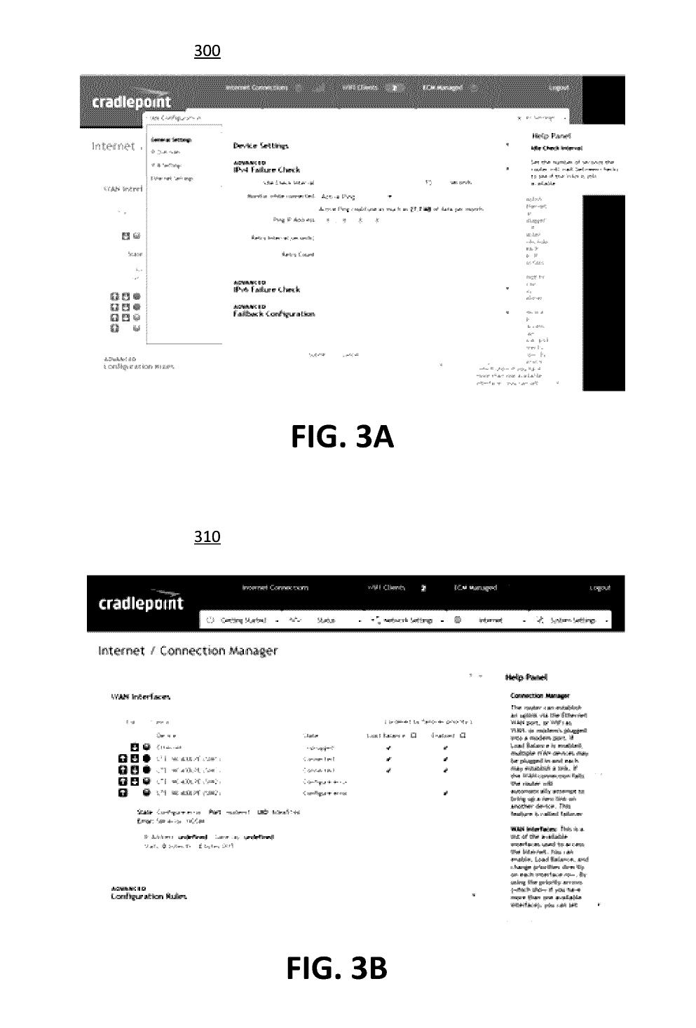

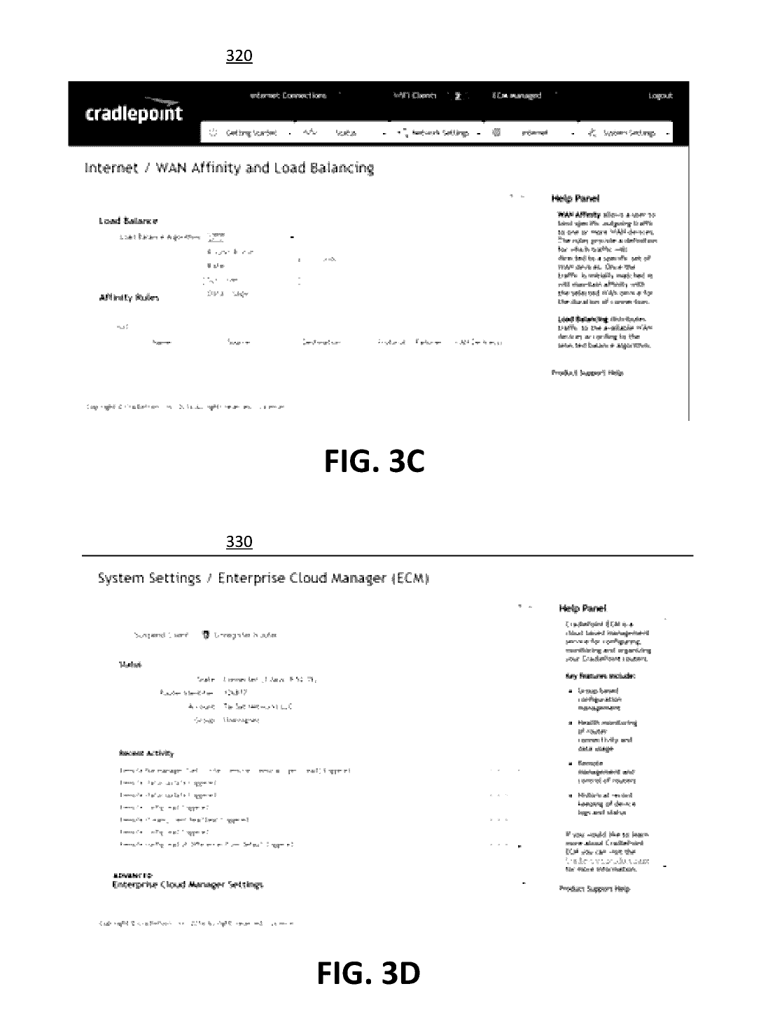

With reference now to FIGS. 3A-3D, 4A-4C, 5A-5C; and 6A-6C, a plurality of screen shots for the programing of rapid response network 100 is shown in accordance with an embodiment. Although specific programing steps are discussed, it should be appreciated that the programming steps may differ based on software version, different hardware devices, or the like. As such, although a specific programming is discussed herein, the settings, names, or components may have different names or GUI interfaces while remaining within the scope of the discussion and Claims provided herewith.

### Programing Router 107

With reference now to FIG. 3A, a screenshot 300 illustrates the programing of the functionality of the failover abilities of router 107. The alteration shown in screenshot 300 will allow router 107 to react automatically if a WAN (Wide Area Network) connection fails. In one embodiment, the steps include, changing the “monitor while connected” to “Active ping”; and change the ping IP address to 8.8.8.8 (this pings Google's servers every 10 sec. if it fails the system will switch to the next WAN connection available).

With reference now to FIG. 3B, a screenshot 310 illustrates additional programing of the functionality of the failover abilities of router 107. The alteration shown in screenshot 310 will change the way router 107 prioritizes WAN connections. In addition, it will activate the 2 LTE modems with SIM 1 and move SIM 2 slots to the lowest priority. Load balancing is then engaged on all modems and WAN ports.

With reference now to FIG. 3C, a screenshot 320 illustrates additional programing of the functionality of the failover abilities of router 107. The alteration shown in screenshot 320 router 107 default “Load Balancing Algorithm” is set to “Round Robin”. This causes router 107 to route network users evenly across all LAN resources. This is reprogramed by selecting “Rate”. This change greatly increases the speed of the users by automatically selecting the fastest LAN connection for each connected user by evaluating all LAN connection with an active ping before the user is connected.

With reference now to FIG. 3D, a screenshot 320 illustrates further programing of the functionality of the failover abilities of router 107. The alteration shown in screenshot 300 sets up the ECM (Enterprise Cloud Management) functionality which is a different setup for each unit. This allows the entire network to be managed globally from any web enabled device. In one embodiment, this completes the programing of router 107.

### Programing Hub 109

In one embodiment, the configuration of hub 109 (e.g., the master node) will disarm all the automatic linking characteristics that an off the shelf unit will have. In general, rapid response network 100 is engineered to establish links between the active nodes 125a-125n much like a wheel with spokes, with hub 109 acting as the Hub of the wheel and subsequent slave nodes extending out from the Hub node as shown in FIG. 1. In one embodiment, rapid response network 100 uses the wireless strategy of “Point to Multipoint” configuration to maximize network performance, throughput and reliability. These alterations in programing discussed herein is what allows rapid response network 100 to provide high speed connectivity for users from 1-2 or rapidly scale up to support over a 100+ users.

In general, dynamic linking has proven to be very unreliable and in some cases linking will fail all to gather or greatly restrict the number of users that can be supported. As such, these functions are turned off.

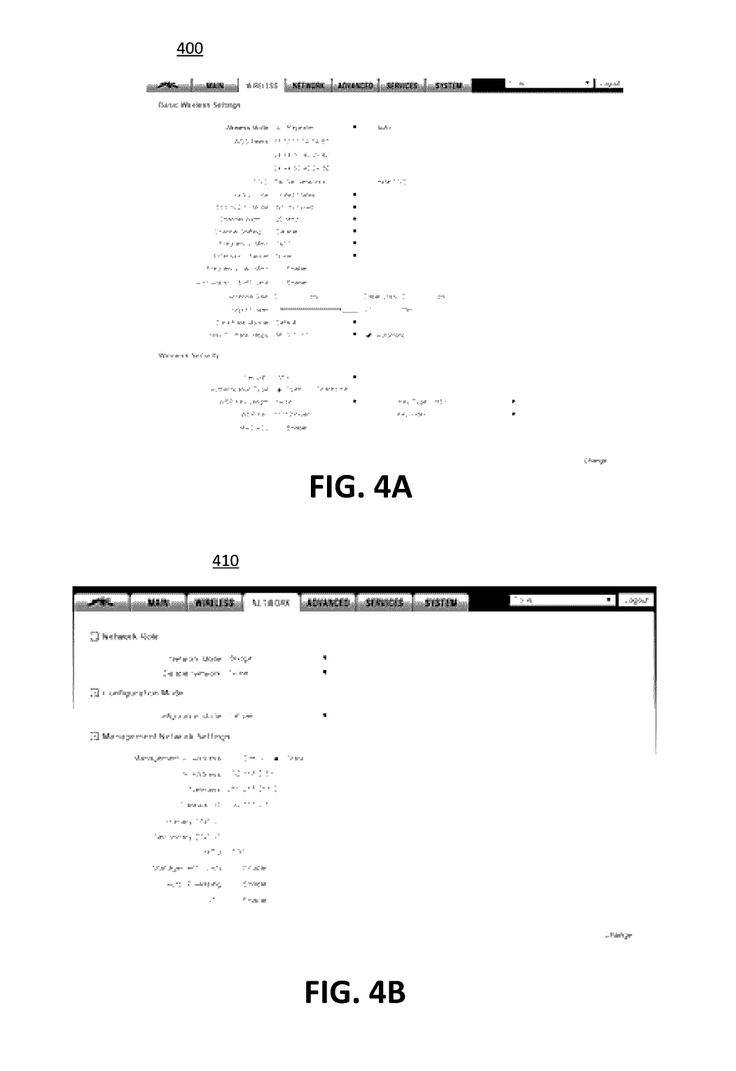

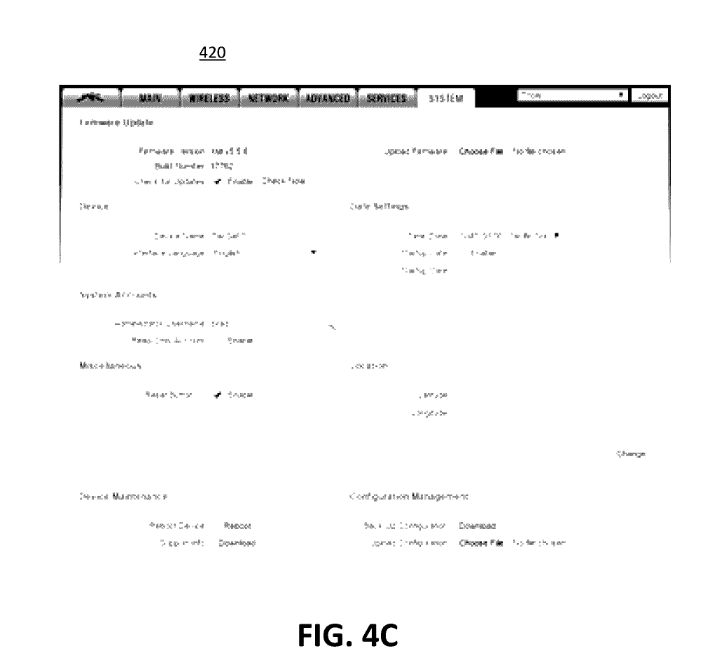

With reference now to FIG. 4A, a screenshot 400 illustrates the programing procedure for hub 109 is shown in accordance with an embodiment. Although specific programing steps are discussed throughout FIGS. 4A-4C, it should be appreciated that the programming may differ based on software version, or on different hardware devices. As such, although a specific programming is discussed herein, the settings, names, or components may have different names or GUI interfaces while remaining within the scope of the discussion and Claims provided herewith.

Referring again to screenshot 400, under the “WIRELESS” tab of the GUI “wireless mode” set to “A/P Repeater; The “Auto Box” is unchecked; In the “WDS Peers” window, enter the MAC addresses of each node 125a-125n (e.g., the slave nodes); In the SSID window enter the SSID of “TacSat Networks”; In the “Channel Width” dropdown menu, select “20 Mhz.”; In the “Frequency, Mhz.” dropdown menu, select “2452”; In the “Wireless Security” section of the page, in the “Security” dropdown menu select “WEP”; “Authentication Type” set to “Open”; “WEP Key Length” set to “64 Bit”; and In the “WEP Key” box enter “8318099046”.

With reference now to FIG. 4B, a screenshot 410 illustrates the continuing programing procedures for hub 109 as shown in accordance with an embodiment. As shown in screenshot 410, the “Network” Tab is selected. “Network Mode” is set to “Bridge”. Under “Management Network Settings”, IP Address is set to “192.168.0.51”; Netmask is set to “255.255.255.0”; and “Gateway IP” is set to “192.168.0.1”

With reference now to FIG. 4C, a screenshot 420 illustrates the continuing programing procedures for hub 109 as shown in accordance with an embodiment. As shown in screenshot 420, the “System” Tab is selected. The device name is changed to “TacSat-51”. The “Administrator Username” is changed to “Tacsat”. The change password window is opened and after the default password is provided, a new password is entered and confirmed. At that point, the “Change” button at the bottom of the page is clicked and after clicking the “Apply” button, the node will reboot and will be ready for use.

Programming Shorter Range Nodes 125a-125n

In one embodiment, each of nodes 125a-125n (e.g., slave nodes) must be programed to operate on the pre-selected frequency and channel width as hub 109. Critical to the effectiveness of the system each of nodes 125a-125n must be programed to only link to hub 109. This is accomplished by programing only the MAC address of hub 109 in the “WDS Peers” window located on the “WIRELESS” tab of the GUI in each of nodes 125a-125n. By not allowing nodes 125a-125n to communicate or link to each other greatly increases the bandwidth capacity of the entire system and greatly increases reliability with very fast deployment and connection times.

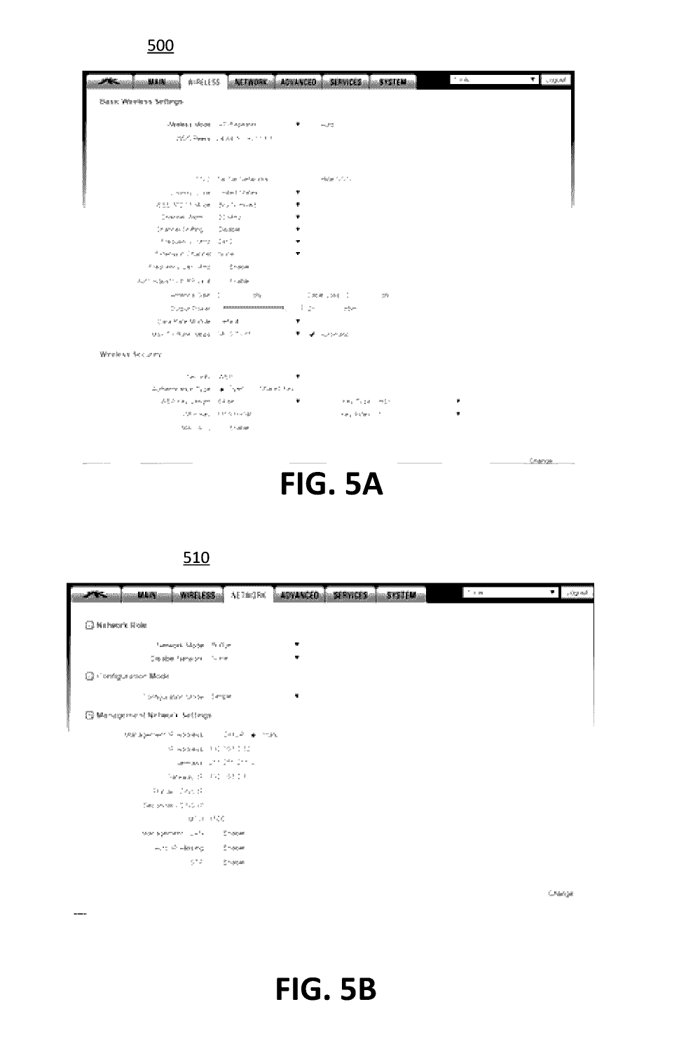

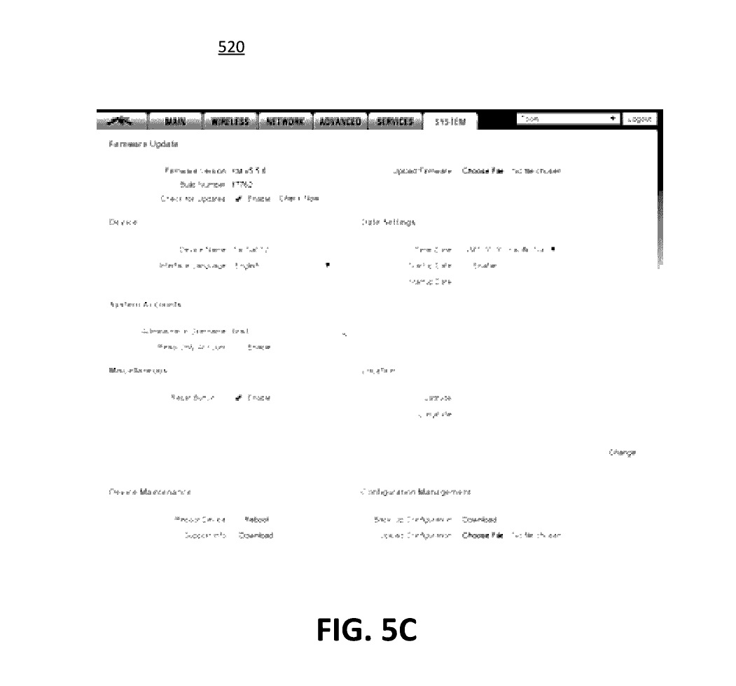

With reference now to FIG. 5A, a screenshot 500 illustrates the programing procedure for nodes 125a-125n is shown in accordance with an embodiment. Although specific programing steps are discussed, it should be appreciated that the programming steps may differ based on software version, different hardware devices, or the like. As such, although a specific programming is discussed herein, the settings, names, or components may have different names or GUI interfaces while remaining within the scope of the discussion and Claims provided herewith.

Referring again to screenshot 500, one embodiment sets wireless mode to “AP-Repeater”. In the “WDS Peers” window enter the MAC address of hub 109 node only. In the “SSID” window enter “TacSat Networks”. Set “Channel Width” to “20 Mhz.”; Set “Frequency, MHz” to “2452”; Set “Security” to “WEP”; Set “Authentication” to “Open”; Set “WEP Key Length” to “64”; Enter “8318099046” in to the “WEP Key” window; and click on the “Change” button.

With reference now to FIG. 5B, a screenshot 510 illustrates the continuing programing procedures for nodes 125a-125n as shown in accordance with an embodiment. As shown in screenshot 510, the “Network” Tab is selected. “Network Mode” is set to “Bridge”. Under “Management Network Settings”, IP Address is set to “192.168.0.52”; Netmask is set to “255.255.255.0”; and “Gateway IP” is set to “192.168.0.1”.

With reference now to FIG. 5C, a screenshot 520 illustrates the continuing programing procedures for nodes 125a-125n as shown in accordance with an embodiment. As shown in screenshot 520, the “System” Tab is selected. The device name is changed to “TacSat-52”. The “Administrator Username” is changed to “Tacsat”. The change password window is opened and after the default password is provided, a new password is entered and confirmed. At that point, the “Change” button at the bottom of the page is clicked and after clicking the “Apply” button, the node will reboot and will be ready for use.

Each different node 125a-125n, is programmed in the same fashion except for the following changes. For each node 125a-125n, under “Management Network Settings”, IP Address is set to a different value. E.g., “192.168.0.53”, “192.168.0.54”, “192.168.0.55”, etc. In addition, for each node 125a-125n, the device name is changed to a different value, e.g., “TacSat-53”, “TacSat-54”, “TacSat-55”, etc.

### Programming Longer Range Node 114 (e.g., Master Long Range Node)

In one embodiment, longer range node 114 is programed for (Point to Point) operation. For example, these units provide high throughput links that can extend out approximately 3 miles when using 22 Dbi high gain antennas. In addition, rapid response network 100 includes link radios which are used to establish two high capacity trunk lines (150+ Mbps.) each, or establishing a non-line of sight link by using 2 radios that are bridged together and by using the Omni antennas at 5 Ghz.

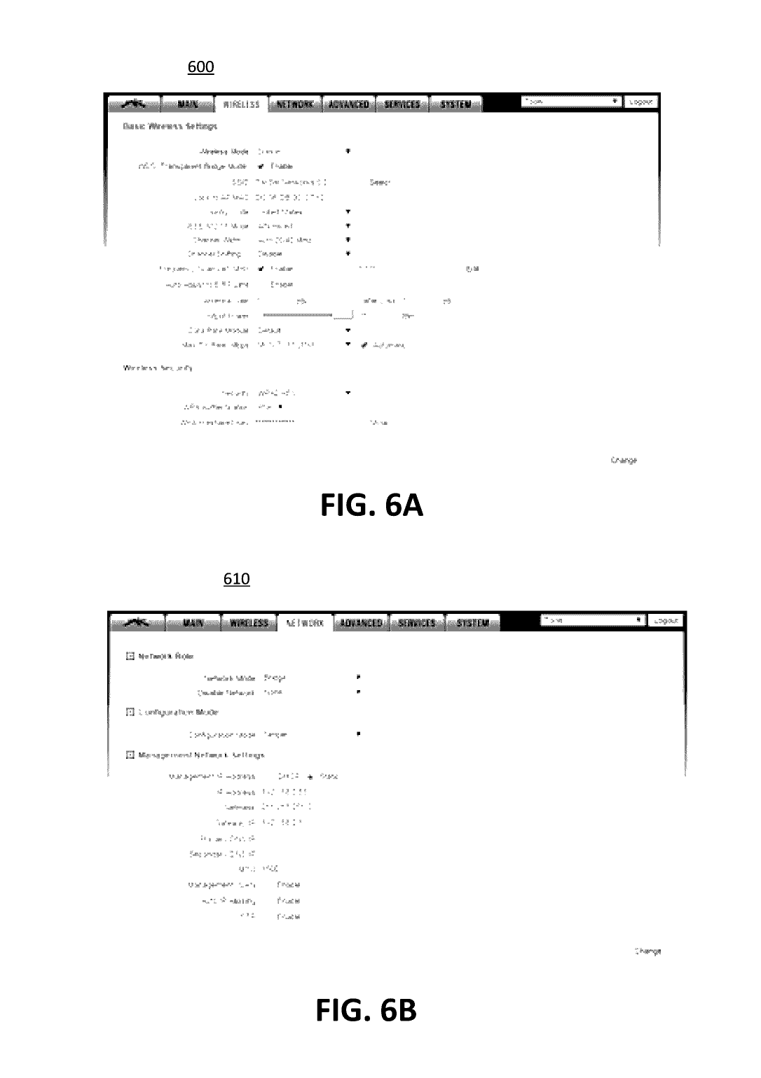

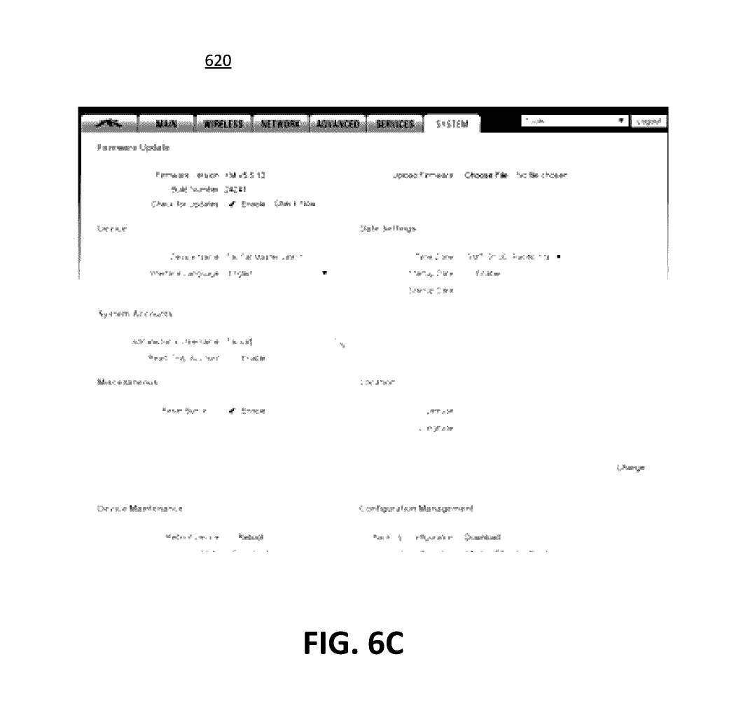

With reference now to FIG. 6A, a screenshot 600 illustrates the programing procedure for longer range node 114 is shown in accordance with an embodiment. Although specific programing steps are discussed, it should be appreciated that the programming steps may differ based on software version, different hardware devices, or the like. As such, although a specific programming is discussed herein, the settings, names, or components may have different names or GUI interfaces while remaining within the scope of the discussion and Claims provided herewith.

Referring again to screenshot 600, one embodiment sets wireless mode to “station”. A check is placed on “WDS(Transparent Bridge Mode” “Enabled”. In the “SSID” window enter “TacSat Networks 5.0”. In the “Lock to AP MAC” enter the MAC address for node (Slave-LINK-1 56); Set “Channel Width” to “auto 20/40 Mhz.”; Enable “Frequency Scan List”; Set “Frequency, MHz” to “5775”; Set “Security” to “WPA-2-AES”; Set “Authentication” to “PSK”; Enter “8318099046” in to the “WPA Presharded Key” window; and click on the “Change” button.

With reference now to FIG. 6B, a screenshot 610 illustrates the continuing programing procedures for longer range node 114 as shown in accordance with an embodiment. As shown in screenshot 610, the “Network” Tab is selected. “Network Mode” is set to “Bridge”. Under “Management Network Settings”, IP Address is set to “192.168.0.55”; Netmask is set to “255.255.255.0”; and “Gateway IP” is set to “192.168.0.1”.

With reference now to FIG. 6C, a screenshot 620 illustrates the continuing programing procedures for longer range node 114 as shown in accordance with an embodiment. As shown in screenshot 620, the “System” Tab is selected. The device name is changed to “TacSat Master LINK-1”. The “Administrator Username” is changed to “Tacsat”. The change password window is opened and after the default password is provided, a new password is entered and confirmed. At that point, the “Change” button at the bottom of the page is clicked and after clicking the “Apply” button, the node will reboot and will be ready for use.

### Programming Longer Range Node 125b (e.g., Slave Long Range Node)

In one embodiment, longer range node 125b is programed for (Point to Point) operation. For example, these units provide high throughput links that can extend out approximately 3 miles when using 22 Dbi high gain antennas. In addition, rapid response network 100 includes link radios which are used to establish two high capacity trunk lines (150+ Mbps.) each, or establishing a non-line of sight link by using 2 radios that are bridged together and by using the Omni antennas at 5 Ghz.

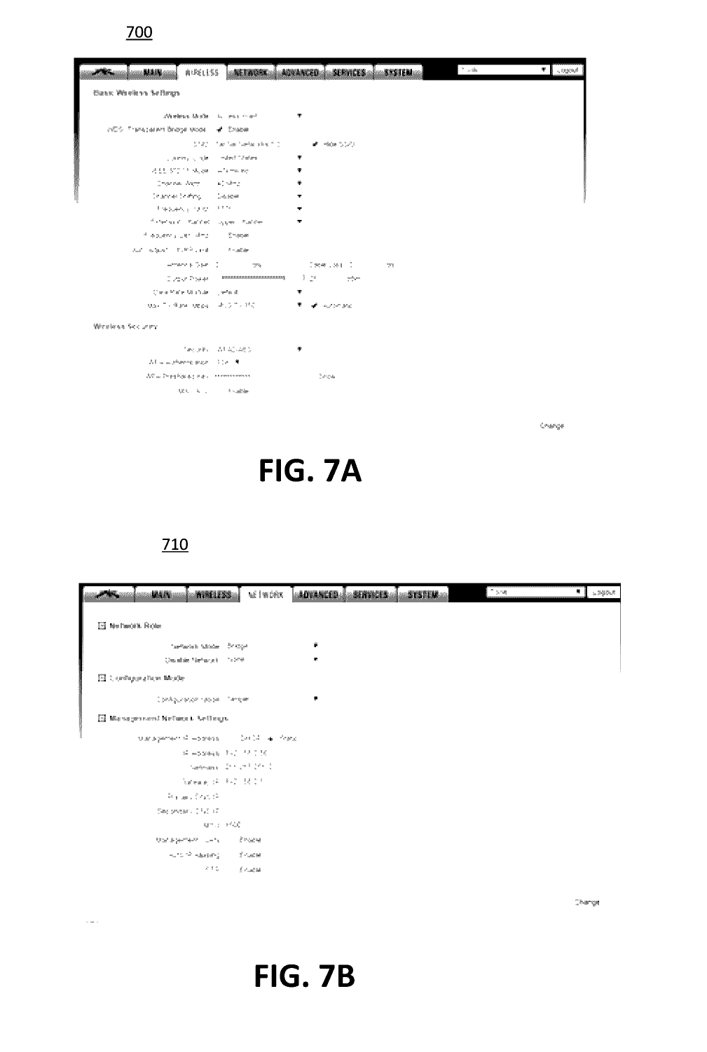

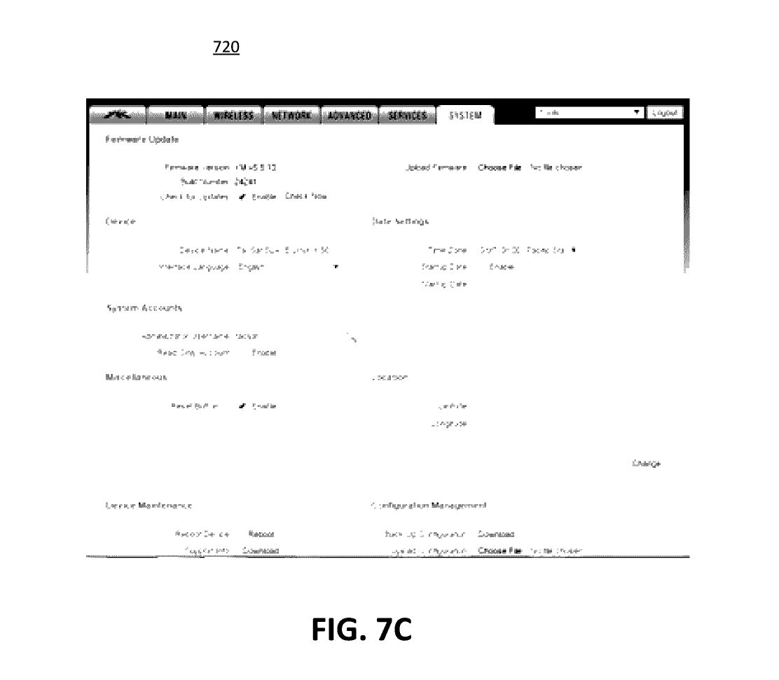

With reference now to FIG. 7A, a screenshot 700 illustrates the programing procedure for longer range node 125b is shown in accordance with an embodiment. Although specific programing steps are discussed, it should be appreciated that the programming steps may differ based on software version, different hardware devices, or the like. As such, although a specific programming is discussed herein, the settings, names, or components may have different names or GUI interfaces while remaining within the scope of the discussion and Claims provided herewith.

Referring again to screenshot 700, one embodiment sets wireless mode to “Access Point”. A check is placed on “WDS(Transparent Bridge Mode” “Enabled”. In the “SSID” window enter “TacSat Networks 5.0”; Set “Channel Width” to “40 Mhz.”; Enable “Frequency, MHz”; Set “Frequency, MHz” to “5775”; Set “Security” to “WPA-2-AES”; Set “Authentication” to “PSK”; Enter “8318099046” in to the “WPA Presharded Key” window; and click on the “Change” button.

With reference now to FIG. 7B, a screenshot 710 illustrates the continuing programing procedures for longer range node 125b as shown in accordance with an embodiment. As shown in screenshot 710, the “Network” Tab is selected. “Network Mode” is set to “Bridge”. Under “Management Network Settings”, IP Address is set to “192.168.0.56”; Netmask is set to “255.255.255.0”; and “Gateway IP” is set to “192.168.0.1”.

With reference now to FIG. 7C, a screenshot 720 illustrates the continuing programing procedures for longer range node 125b as shown in accordance with an embodiment. As shown in screenshot 720, the “System” Tab is selected. The device name is changed to “TacSat SLAVE LINK-1 56”. The “Administrator Username” is changed to “Tacsat”. The change password window is opened and after the default password is provided, a new password is entered and confirmed. At that point, the “Change” button at the bottom of the page is clicked and after clicking the “Apply” button, the node will reboot and will be ready for use.

In general, each different long range master node-slave node pair is programmed in the same fashion as described above to include a change in the naming for uniqueness purposes and the proper master/slave mac address set-up.

Thus, embodiments as described comprise a new and non-obvious combination of a variety of network components in order to create unique ruggedized portable and scalable communications system suitable for use in harsh and demanding environments. These harsh environments include, but are not limited to, forest and/or urban fire cites, disaster locations, and other regions where conventional communications are not available or suitable for use by, for example, firefighters and emergency responders.

Advantages of rapid response network 100 include, but are not limited to, 2.4 GHz. wireless nodes that are programed to operate in the Point to Multipoint network design and have the ability to mesh. 5 GHz. wireless nodes programed for Point to Point trunk lines for very high capacity links that can extend the network out for miles, 2.4 GHz. nodes can be added to the end points as needed to provide wireless or wired connectivity to users. One or all components have the ability to operate on standard 12 volt DC power with very low power consumption, and are well suited for solar or other remote power options.

Rapid response network 100 is equipped with duel LTE cellular data modems that are high power units (600 Miliwatts) and utilize high gain directional paddle LTE antennas. This allows rapid response network 100 to establish LTE connectivity at far greater distances from the providers Cellular tower 112. Moreover, router 107 is able to balance all possible WAN resources together to create a very large high bandwidth internet connection which can easily accommodate 130 users or more.

Further, rapid response network 100 has the ability to be full managed and programed from any off site location by any web enabled device. Moreover, rapid response network 100 has advanced network security and intruder alert reporting; can monitor data usage; and includes, QOS, content filtering, MAC filtering, Domain Filtering and ‘White List” or “Black List” access control, VPN tunneling and acceleration.

Moreover, rapid response network 100 is capable of establishing up to 99 separate network IP segments that are isolated from each other and can be bridged as needed. In addition, rapid response network 100 can provide a WiFi Hot Spot that is fully controllable by the admin operating the system. rapid response network 100 also includes Independent VoIP phone modems that can be located together or independently anywhere on the network. Each having dedicated phone numbers and providing a standard “POTS” dial tone. This allows for ether voice or fax service to be provided anywhere on the network.

In one embodiment, the cellular service can be expanded by utilizing an optional high gain sector antenna which can reach out miles depending on terrain. The Ka band VSAT terminal (Optional) will provide reliable high speed connectivity and has no restrictions on the type of data used, this means VoIP phones, RoIP devices, faxes can be used effectively without any additional service costs or configurations. Moreover, this system operates on both AC and 12 Volt DC power.

In one embodiment, additional components can be added to the system like LMR (Land Based Radio systems) or digital radio gateways that will provide RF radio connectivity to connect dispatch locations or for repeater linking.

### Example Computer System Environment

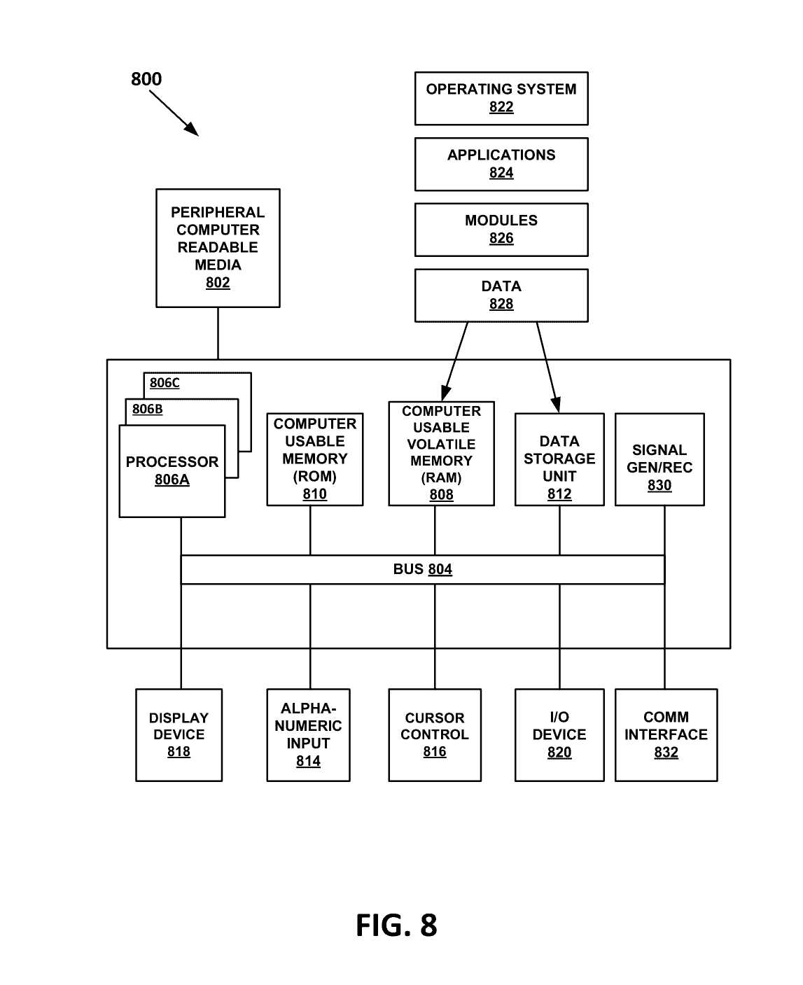

With reference now to FIG. 8, portions of the technology for providing a communication composed of computer-readable and computer-executable instructions that reside, for example, in non-transitory computer-readable storage media of a computer system. That is, FIG. 8 illustrates one example of a type of computer that can be used to implement embodiments of the present technology. FIG. 8 represents a system or components that may be used in conjunction with aspects of the present technology. In one embodiment, some or all of the components described herein may be combined with some or all of the components of FIG. 8 to practice the present technology.

FIG. 8 illustrates an example computer system 800 used in accordance with embodiments of the present technology. It is appreciated that system 800 of FIG. 8 is an example only and that the present technology can operate on or within a number of different computer systems including general purpose networked computer systems, embedded computer systems, routers, switches, server devices, user devices, various intermediate devices/artifacts, stand-alone computer systems, mobile phones, personal data assistants, televisions and the like. As shown in FIG. 8, computer system 800 of FIG. 8 is well adapted to having peripheral computer readable media 802 such as, for example, a disk, a compact disc, a flash drive, and the like coupled thereto.

Computer system 800 of FIG. 8 includes an address/data/control bus 804 for communicating information, and a processor 806A coupled to bus 804 for processing information and instructions. As depicted in FIG. 8, system 800 is also well suited to a multi-processor environment in which a plurality of processors 806A, 806B, and 806C are present. Conversely, system 800 is also well suited to having a single processor such as, for example, processor 806A. Processors 806A, 806B, and 806C may be any of various types of microprocessors. Computer system 800 also includes data storage features such as a computer usable volatile memory 808, e.g., random access memory (RAM), coupled to bus 804 for storing information and instructions for processors 806A, 806B, and 806C.

System 800 also includes computer usable non-volatile memory 810, e.g., read only memory (ROM), coupled to bus 804 for storing static information and instructions for processors 806A, 806B, and 806C. Also present in system 800 is a data storage unit 812 (e.g., a magnetic disk drive, optical disk drive, solid state drive (SSD), and the like) coupled to bus 804 for storing information and instructions. Computer system 800 also includes an optional alpha-numeric input device 814 including alphanumeric and function keys coupled to bus 804 for communicating information and command selections to processor 806A or processors 806A, 806B, and 806C. Computer system 800 also includes an optional cursor control device 816 coupled to bus 804 for communicating user input information and command selections to processor 806A or processors 806A, 806B, and 806C. Optional cursor control device may be a touch sensor, gesture recognition device, and the like. Computer system 800 of the present embodiment also includes an optional display device 818 coupled to bus 804 for displaying information.

Referring still to FIG. 8, optional display device 818 of FIG. 8 may be a liquid crystal device, cathode ray tube, OLED, plasma display device or other display device suitable for creating graphic images and alpha-numeric characters recognizable to a user. Optional cursor control device 816 allows the computer user to dynamically signal the movement of a visible symbol (cursor) on a display screen of display device 818. Many implementations of cursor control device 816 are known in the art including a trackball, mouse, touch pad, joystick, non-contact input, gesture recognition, voice commands, bio recognition, and the like. In addition, special keys on alpha-numeric input device 814 capable of signaling movement of a given direction or manner of displacement. Alternatively, it will be appreciated that a cursor can be directed and/or activated via input from alpha-numeric input device 814 using special keys and key sequence commands.

System 800 is also well suited to having a cursor directed by other means such as, for example, voice commands. Computer system 800 also includes an I/O device 820 for coupling system 800 with external entities. For example, in one embodiment, I/O device 820 is a modem for enabling wired or wireless communications between system 800 and an external network such as, but not limited to, the Internet or intranet. A more detailed discussion of the present technology is found below.

Referring still to FIG. 8, various other components are depicted for system 800. Specifically, when present, an operating system 822, applications 824, modules 826, and data 828 are shown as typically residing in one or some combination of computer usable volatile memory 808, e.g. random access memory (RAM), and data storage unit 812. However, it is appreciated that in some embodiments, operating system 822 may be stored in other locations such as on a network or on a flash drive; and that further, operating system 822 may be accessed from a remote location via, for example, a coupling to the internet. In one embodiment, the present technology, for example, is stored as an application 824 or module 826 in memory locations within RAM 808 and memory areas within data storage unit 812. The present technology may be applied to one or more elements of described system 800.

System 800 also includes one or more signal generating and receiving device(s) 830 coupled with bus 804 for enabling system 800 to interface with other electronic devices and computer systems. Signal generating and receiving device(s) 830 of the present embodiment may include wired serial adaptors, modems, and network adaptors, wireless modems, and wireless network adaptors, and other such communication technology. The signal generating and receiving device(s) 830 may work in conjunction with one or more communication interface(s) 832 for coupling information to and/or from system 800. Communication interface 832 may include a serial port, parallel port, Universal Serial Bus (USB), Ethernet port, Bluetooth, thunderbolt, near field communications port, WiFi, Cellular modem, or other input/output interface. Communication interface 832 may physically, electrically, optically, or wirelessly (e.g., via radio frequency) couple computer system 800 with another device, such as a mobile phone, radio, or computer system.

The computing system 800 is only one example of a suitable computing environment and is not intended to suggest any limitation as to the scope of use or functionality of the present technology. Neither should the computing environment be interpreted as having any dependency or requirement relating to any one or combination of components illustrated in the example computing system 800.

The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

The foregoing Description is not intended to be exhaustive or to limit the embodiments to the precise form described. Instead, example embodiments in this Description have been presented in order to enable persons of skill in the art to make and use embodiments of the described subject matter. Moreover, various embodiments have been described in various combinations. However, any two or more embodiments may be combined. Although some embodiments have been described in a language specific to structural features and/or methodological acts, it is to be understood that the subject matter defined in the appended claims is not necessarily limited to the specific features or acts described above. Rather, the specific features and acts described above are disclosed by way of illustration and as example forms of implementing the claims and their equivalents.

What is claimed is:

1. A rapid response network comprising:
a router having a connection to a data service;
a hub having a mac address, said hub communicatively coupled with said router; and
at least one node having a mac address, said at least one node communicatively coupled with said hub, said at least one node manually configured to only communicate with said hub as designated by said hub mac address.

2. The rapid response network of claim 1, wherein said data service is a satellite network connection.

3. The rapid response network of claim 1, wherein said data service is a long-term evolution (LTE) network connection.

4. The rapid response network of claim 1, wherein said data service is a wired network connection.

5. The rapid response network of claim 4, wherein said wired network connection is selected from the group consisting of: a cable network connection, a digital subscriber line (DSL) network connection, and an optical fiber network connection.

6. The rapid response network of claim 1, wherein said data service is selected from two or more data service providers from the group consisting of: a satellite network connection, an LTE network connection, and a wired network connection.

7. The rapid response network of claim 1, further comprising:
said hub manually configured to only communicate with said at least one node as designated by said mac address of said at least one node being programmed into said hub.

8. The rapid response network of claim 1, further comprising:
a plurality of nodes, each of said plurality of nodes having a different mac address, said plurality of nodes communicatively coupled with said hub, said plurality of nodes manually configured to only communicate with said hub as designated by a previously provided hub mac address; and
said hub manually configured to only communicate with any of said plurality of nodes having a designated mac address previously provided to said hub.

9. The rapid response network of claim 1, further comprising:
one or more devices communicatively coupleable with said at least one node, said one or more devices selected from the group consisting of: a mobile communications device, a computer system, a printer, and a camera.

10. The rapid response network of claim 1, further comprising:
a solar power source for powering said router.

11. The rapid response network of claim 1, further comprising:
a cellular network extender to create a cell tower to provide cellular phone service capabilities to said rapid response network.

12. The rapid response network of claim 1, further comprising:
said at least one node manually configured to only communicate with said hub on a predefined frequency.

13. The rapid response network of claim 1, further comprising:
said at least one node manually configured to only allow designated linking, and not allow dynamic linking, with another node, said designated linking based on a predefined node mac address.

14. The rapid response network of claim 1, wherein each of said router, said hub, and said at least one node operate on 12 volt DC power.

15. The rapid response network of claim 1, further comprising:
an access control list for said at least one node, said access control list to control which devices are able to utilize said at least one node.

16. The rapid response network of claim 1, further comprising:
said at least one node to act as a Wi-Fi hotspot.

17. The rapid response network of claim 1, further comprising:
a land based radio system to provide RF radio connectivity to said rapid response network.

18. The rapid response network of claim 1, further comprising:
a digital radio gateway to provide RF radio connectivity to said rapid response network.

19. A method for forming a rapid response network, said method comprising:
communicatively coupling a router with a data service;
communicatively coupling a hub with said router to access said data service via said router;
obtaining a node media access control (MAC) address list for each of one or more nodes to be deployed;
providing said node MAC address list to said hub;
manually configuring said hub to only communicate with only the one or more nodes whose MAC address is on said node MAC address list;
obtaining a hub MAC address;
providing a MAC address list to each of the one or more nodes, the MAC address list comprising said hub MAC address;
manually configuring each of the one or more nodes to only communicate with said hub whose MAC address is on said MAC address list,
each of the one or more nodes manually configured to only allow designated linking, and not dynamic linking, with said hub whose MAC address is on said MAC address list; and
communicatively coupling one or more devices with the one or more nodes to establish the rapid response network, said one or more devices selected from the group consisting of: a mobile communications device, a computer system, a printer, and a camera.

20. The method of claim 19, further comprising:
obtaining a device identifier for each of said one or more devices,
generating an access control list for said one or more devices based on said device identifier, said access control list to control which devices are able to utilize said one or more nodes; and
providing said access control list to each of said one or more nodes; and
limiting access to said one or more nodes, by said one or more devices, based on said access control list.
